(19) United States
(12) Patent Application Publication
(10) Pub. No.: US 2009/0313538 A1
(43) Pub. Date: Dec. 17, 2009

(54) DESIGN GENERATING APPARATUS, DESIGN GENERATION METHOD, AND STORAGE MEDIUM STORING DESIGN GENERATION PROGRAM

(75) Inventor: Atsushi Kitada, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/485,563

(22) Filed: Jun. 16, 2009

(30) Foreign Application Priority Data
Jun. 17, 2008 (JP) 2008-157610

(51) Int. Cl. G06F 17/00

(52) U.S. Cl. 715/243

(57) ABSTRACT

A user may have trouble selecting a desired design when too many generated designs are displayed on a list. There is also a problem that the user cannot easily create a derived design if the user has little design knowledge when the user needs the derived design based on the desired design among the generated designs.

Included are: a memory unit that stores a template of a basic design corresponding to a combination of a character and an image and a template of a derived design associated with the basic design; and a generating unit that applies the entered character or image to the template of the basic design read from the memory unit to generate a basic design and display the basic design on a display unit, reads the template of the derived design associated with the basic design selected, based on the operation by the user, from the memory unit, and applies the character or image used to generate the basic design to generate the derived design and display the derived design on the display unit.

### BACKGROUND OF THE INVENTION

1. Field of the Invention

The present invention relates to an apparatus, a method, and a storage medium storing a program, for displaying, on a display, a layout design with text data and image data.

2. Description of the Related Art

Conventionally, a variety of types of application software that run on personal computers have been released to make up page designs, such as posters, catalogs, presentation data, postcards, leaflets, and advertisements.

The software for making up the page designs includes a function of conventionally well-known DTP (desktop publishing). More specifically, the software includes functions for arranging and editing page design elements, such as images, characters, and clip arts, as well as functions for shading and decorating the images and characters, and a printing function for outputting the designs to a large-size printer.

Page design applications can be classified into expensive, highly-functional applications used by professional designers and relatively inexpensive, general applications with simple operations and processes.

The breadth of the functions tends to be emphasized as more important than the operability in the expensive, highly-functional applications to better and more accurately reflect the intensions of the designers. General users need time to learn, and the products are complicated for the users to manipulate.

On the other hand, the general applications are targeted for the users who can operate office applications on some level, such as OS (operating system), word processor, and spreadsheet on a personal computer. Therefore, in some general applications, the operations extending to the page design printing are simplified, and there are products that guide not only the editing operations, but also the creation flow of the print setting.

The general applications often include materials for efficiently creating page designs, such as design templates (models) designed in advance, clip arts, and photographs, to realize high-quality page designs with simple operations.

The user takes procedures for completing the page design, such as selecting a design template close to the complete image of the intended page design, and editing the design by appropriately replacing a photograph, editing the text, adding other materials, and applying the decoration effect.

General users who have not acquired sufficient knowledge of layout design and color design require a large amount of time to make up desired page designs from completely blank sheets, and the desired designs may not be always obtained. The “desired page design” is in a state that satisfies accurate transmission of content, excellent readability, and strong impression if possible for the subjects such as readers and observers of the page design. Basic design knowledge and know-how, such as layout and coloration, are required to make up the page designs in such a state.

In the page design creation of recent years, some techniques for designating not only the procedure of selecting an existing design template, but also a design image that gives an impression to the page design readers and observers, thereby generating variations of layout and coloration of the page design and selecting a variation close to the desired image from the variations are disclosed.

For example, Japanese Patent Application Laid-Open No. H07-306935 discloses a technique for the user to select a coloration image that determines the impression of page design by coloration, thereby determining the most important color in the image, generating and combining other colors that match the most important color, and coloring the page design. A database for storing the coloration image selected by the user is included to realize the technique. This can easily approximate the impression of the created page design to the user's desired design.

Furthermore, Japanese Patent Application Laid-Open No. H09-146948 discloses a technique for determining a page layout based on a desired arrangement of page design elements received from the user. To realize the technique, the technique includes a layout means that holds restrictions related to the arrangement of the page design elements as a rule base and that arranges the page design elements to the arrangement area designated by the user based on the restrictions. This allows appropriate arrangements of newly made up and inserted page design elements.

Japanese Patent Application Laid-Open No. H11-232474 discloses a page design creation technique for displaying a variation of a design template meeting page design conditions received from the user and combining the page design and the page design material designated by the user.

In Japanese Patent Application Laid-Open No. H11-232474, the user selects a variation close to the desired complete image from the variations and then appropriately adds and replaces constituent elements designated by the user, such as images and texts, to complete the image.

In recent years, application software is released for dynamically generating a page design based on page constituent elements, purposes, and conditions designated by the user. The application provides a means that dynamically generates several hundreds of page designs by inputting images, clip arts, texts, and page orientations used for the page designs and that allows the user to select a design. Thumbnails of the generated page designs are displayed on two-dimensional coordinates with the presence/absence of background designs indicated on the horizontal axis and the size of the subjects indicated on the vertical axis. The display method is useful as a standard for the user to select a desired design. Additionally, a coloration image indicating the impression of the page design can be selected on the page design selected by the user. A color palette and a plurality of combinations (color variations) of colors on the color palette are defined for each coloration image in the background of the coloration technique.

The user selects a selected coloration image and color variations belonging to the selected coloration image. Based on the techniques, the application comprehensively supports the page design creating operation by the user.

The edit application that automatically presents the page design candidates to the user is useful for presenting page designs for general users with little knowledge of design because various design know-hows are included.

However, presenting more design candidates degrades the visibility of the list on the screen, and the user is not sure which design to choose. If few candidates are presented, there is a dilemma that the user's selection is narrowed down.

Meanwhile, the same designs and designs with the same taste can be seen on posters with different paper sizes (aspect ratios) in actual stores depending on the displayed locations. The posters with different paper sizes usually give identical information and impression to the observers even though the size of characters, figures and images as constituent elements on the poster, and their relative positions are laid out according to the paper size.

In many occasions, a landscape designed poster is hung from the ceiling and a portrait designed poster is displayed on the poles, depending on the layout of the sales room.

Thus, there is a problem in the conventional techniques that the operation of creating designs with different paper sizes derived from one poster design is difficult for the user with little design knowledge.

Furthermore, there is a problem that it is likely that the design made up by the user with little design knowledge is not aesthetically preferable.

### SUMMARY OF THE INVENTION

An object of the present invention is to provide a design editing apparatus that can more easily obtain a design group with size variations and that can improve the operation efficiency of design creation when the generated design is preferable for the user even if the user has little design knowledge.

The present invention stores a template group as a database, the template group having designs corresponding to the types of entered characters and the number of images, and generates a design group by applying the characters and images entered by the user to the templates corresponding to the types of characters and the number of images entered by the user. The templates are associated with a template group as a size variation group, with different paper sizes having the same design impression, and the templates in the size variation group is used to automatically generate a design group with different paper sizes.

Further features of the present invention will become apparent from the following description of exemplary embodiments with reference to the attached drawings.

### BRIEF DESCRIPTION OF THE DRAWINGS

FIG. 1 illustrates a main screen 10 of a page design application as a first embodiment of the present invention.

FIG. 2 illustrates a basic layout design group generating screen 20 for generating a basic layout design group.

FIG. 3 illustrates a basic layout design group display screen 30.

FIG. 4 illustrates a size variation design display screen 40.

FIG. 5 is a flow chart of a process of displaying a basic layout design group display screen according to an input by the user.

FIG. 6 schematically illustrates a file structure 50 of a selected basic design.

FIG. 7 is a flow chart of a process after the user has selected a basic layout design and a size variation button 33 illustrated in FIG. 3 is pressed.

FIG. 8 illustrates a concept of a basic layout database storing template groups 61 made up by the graphic designer.

FIG. 9 illustrates an example of types of designs based on an entered character group.

FIG. 10 illustrates index data 80 for searching and specifying a template on the basic layout database.

FIG. 11 illustrates a correspondence table 90 of numbers of entered character groups stored in the index data 80 illustrated in FIG. 10 and types of combinations of entered characters.

FIG. 12 is a block diagram of a computer that executes a page design application of the present invention.

### DESCRIPTION OF THE EMBODIMENTS

The exemplary embodiments of the invention are as follows.

### First Embodiment

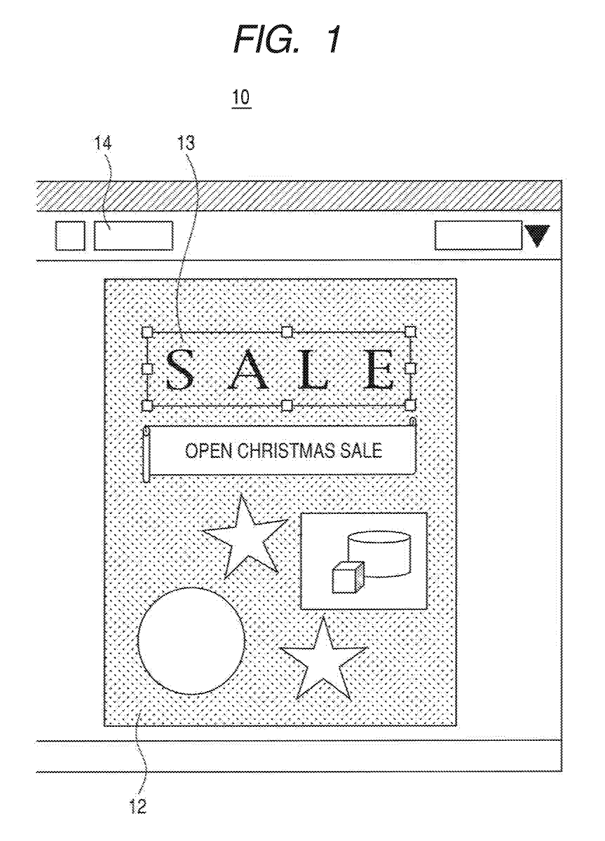

FIG. 1 illustrates a main screen 10 of a page design application as a first embodiment of the present invention.

The first embodiment describes a page design variation automatic generation function operated as part of application software on a personal computer.

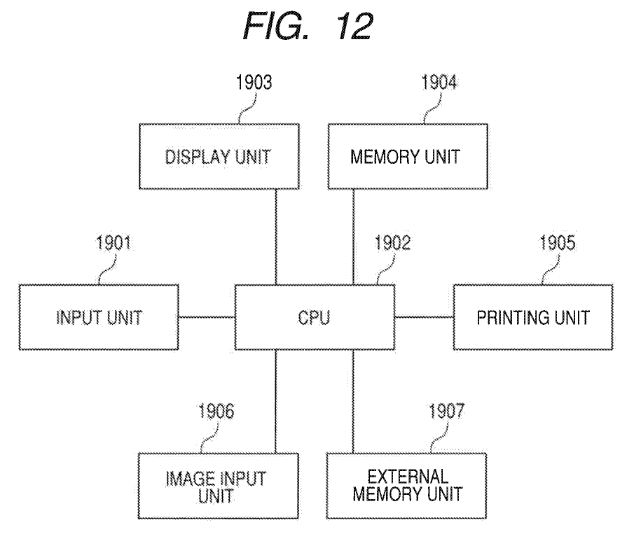

FIG. 12 is a block diagram of an apparatus (personal computer) that executes a program of the page design application, the apparatus serving as an embodiment of the present invention. In the present embodiment, the user operates the page design application (design editing application software) to make up and edit the page design on a poster or a writing (also called a document).

In FIG. 12, an input unit 1901 is a keyboard, a mouse, a pen input unit, or a touch panel. A CPU 1902 controls the system management, inputs and corrects an entered image, and generates edit data for printing. A display unit (display) 1903 is used for the display. A memory unit 1904 of a hard disk stores the image data file and a corresponding image correction command history file. A printing unit 1905 outputs edit data. An image input unit 1906 is a film scanner, a flat bed scanner, or a digital camera. An external memory unit 1907 corresponds to a medium used in a Floppy (registered trademark) drive and a digital camera.

The program of the page design application is stored in the memory unit 1904, and the CPU 1902 reads and executes the program. The CPU 1902 executes the program of the page design application to display a main screen 10 of FIG. 1 on the display unit 1903 and makes up and edits the page design based on the user's operation of the input unit 1901 to display the page design on the main screen 10.

The page design edited by the application may be a general office document, or may be a document with a specific application such as a poster, a postcard, and presentation data.

The page design application includes various functions for editing the page design and is capable of resizing, moving and rotating the page constituent elements, correcting an image, editing a text, decorating a photograph and a text, and setting the background. The page design based on the functions is edited on the main screen 10. The page design made up and edited by displaying on the main screen 10 can be stored as a file in the memory unit 1904 and the external memory unit 1907 with an operation not shown. The printing unit 1905 directly connected to the computer and a printer (not shown) connected through a network can print the page design displayed on the main screen 10 and the page design stored as a file by an operation not shown. The page design displayed on the main screen 10 and the page design stored as a file can be transferred to another computer or server by an operation not shown, printed from another computer or server, and disclosed on a network.

FIG. 1 illustrates a state that a design template attached to the application is displayed on the main screen 10 of the page design application.

The main screen 10 of the page design application includes a screen (not shown) that displays a list of art works. The “art works” is a generic term of the elements constituting the page design, such as photographs, clip arts, photograph frames, character decoration, background, etc. The main screen 10 further includes a menu, a tool bar, and buttons corresponding to various processes for the art works.

The page design application also includes an area (hereinafter, “preview area”) for displaying a selected page design in the document to be edited. Reference numeral 12 of FIG. 1 is an example of the preview area. In the preview area, edit operations can be executed, such as moving and resizing of the constituent elements on the page design (hereinafter, the individual constituent elements are collectively called “objects”).

The user uses an input device, such as a mouse and a keyboard, connected to the personal computer to enter a command or execute an editing operation.

The currently edited entire page design is displayed on the preview area 12. Although a document constituted by one page is edited in the first embodiment, a document with a plurality of pages may be edited. In that case, the application needs to include a page movement command for moving to an arbitrary page so that the user can move to a desired page. The application may also include an edit support function, such as a guide, a grid, and a ruler, so that the objects can be smoothly arranged on intended locations.

A selected state 13 is a selected state that a text object “SALE” on the page design is selected. The user can put a desired object into the selected state by clicking the mouse or operating the TAB key on the keyboard.

A basic layout variation generation button 14 is displayed on the tool bar. Other processing buttons and a display magnification designation drop-down list of the preview area are also arranged on the tool bar. When the basic layout variation generation button 14 is clicked, a screen for generating a new basic layout design group is displayed.

The first embodiment is characterized in that a derived layout design (also called “derived design” or “variation design”) as a variation of a basic layout design selected by the user from the basic layout designs displayed on the basic layout design group display screen is generated. In the present embodiment, basic layout design templates describing design structures for generating the basic layout design group is stored in the memory unit 1904 as a file. A template describing design structures for generating derived layout designs associated with the basic layout design templates are also stored in the memory unit 1904 as a file. The basic layout designs and the associated derived layout designs are collectively called variation groups. If there is at least one derived layout design template associated with one basic layout design template, the files of the basic layout design templates and the derived layout design templates are stored and managed together. The layout designs made up mainly by the graphic designer are converted into data to form the templates, and the templates describe design structures made of combinations of character data and raster data, such as photographic images, or vector data, such as figures, and formed of the arrangement (layout) of the data are described.

To generate a basic layout design or a derived layout design, the CPU 1902 reads, from the memory unit 1904, the template of the basic layout design data corresponding to the combination of the character data and the raster data or the vector data instructed and input by the user operation to be used for the design to generate the design and displays the design on the display unit 1903.

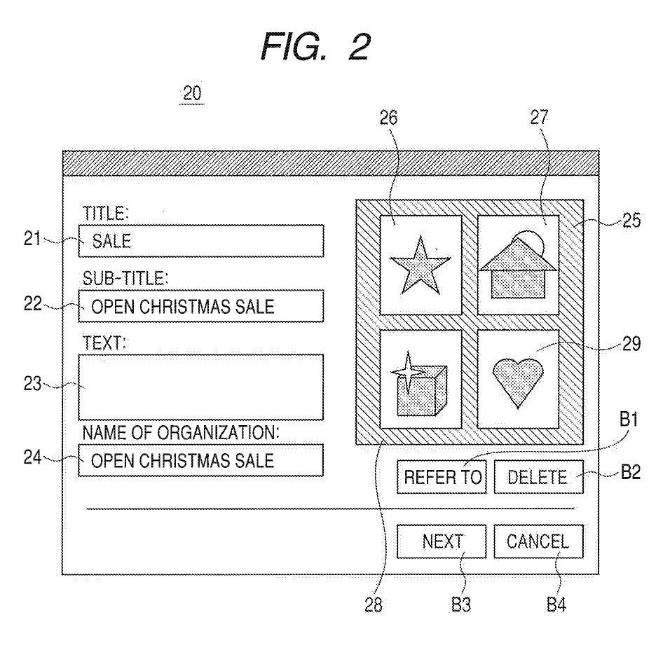

FIG. 2 illustrates a basic layout design group generating screen 20 for generating a basic layout design group.

The basic layout design group generating screen 20 displays a title entering area 21, a sub-title entering area 22, a text entering area 23, an organization name entering area 24, and a user image entering area 25. Images input to the user image entering area 25 form a data file with raster data, such as photographic images, vector data, such as figures, or combination of the data. Bitmap data and JPEG data are examples of the raster data, page data and image data made up by an application that can edit figures and stored in a vector format are examples of the vector data, and vector data including the bitmap data or JPEG data is an example of the mixed data file. FIG. 2 illustrates an example in which four images are input to the user image entering area 25, and the four images are described as a first user entered image 26, a second user entered image 27, a third user entered image 28, and a fourth user entered image 29. The number of images is not limited to four, and 1 to i (i is a natural number greater than 1) images can be input in the present invention. The basic layout design group generating screen 20 further displays an entered image reference button B1, an entered image delete button B2, a “NEXT” button B3, and a cancel button B4.

A poster is contemplated as a document designed to be made up on the basic layout design group generating screen 20. The user enters necessary information on the screen, and the page design application generates a basic layout design group and displays the group on the next screen.

The user enters, on an as needed basis, the title, sub-title, text, and name of organization used for the poster into the title entering area 21, the sub-title entering area 22, the text entering area 23, and the organization name entering area 24, respectively, on the basic layout design group generating screen 20.

The user also enters an image used for the poster into the user image entering area 25. The user can enter the image using a mouse to drag and drop a file on the file system. The user can also enter the image by pressing the entered image reference button B1 to use a general file entering dialogue not shown.

There are priorities in the order of arrangement of images in the user image entering area 25, and the priorities are in descending order from upper left to lower right. Specifically, the priority order is: the first user image 26, the second user image 27, the third user image 28, and the fourth user image 29. The user can use the mouse to drag a thumbnail of the image entered into the user image entering area 25 to switch the location to arbitrarily change the order.

The user can also press the entered image delete button B2 to delete an unnecessary image.

After the completion of necessary inputs, the user presses the “NEXT” button B3 to instruct the generation of the basic layout design group.

The user can also press the cancel button B4 at an arbitrary timing to cancel the input on the screen and return to the main screen of the application.

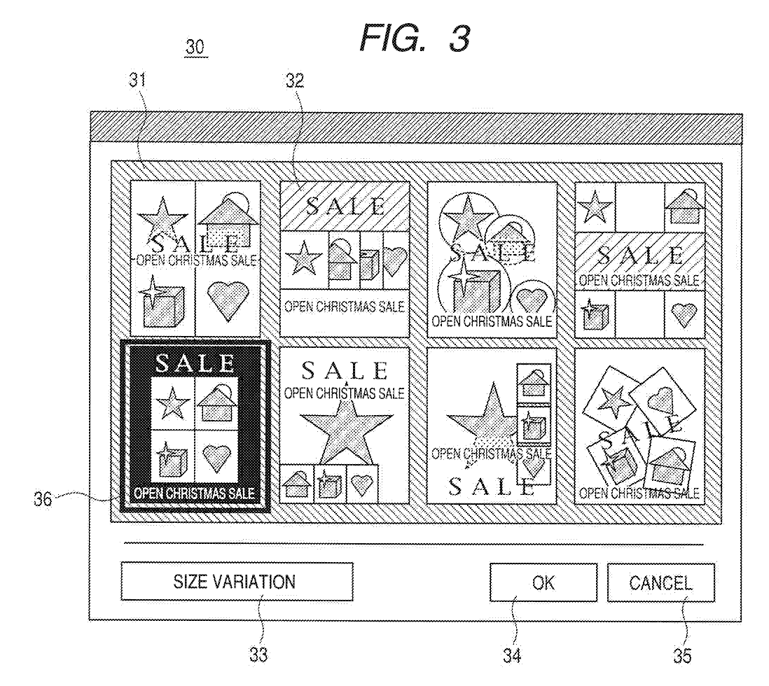

FIG. 3 illustrates a basic layout design group display screen 30.

The basic layout design group display screen 30 is displayed when the “NEXT” button B3 is pressed in FIG. 2.

The basic layout design group display screen 30 displays a basic layout design display area 31, basic layout design thumbnails 32, a size variation button 33, an OK button 34, and a cancel button 35.

The page design application displays a plurality of basic layout design groups, to which character information and image information input by the user in FIG. 2 are applied, as the basic layout design thumbnails 32 in the basic layout design display area 31 on the basic layout design group display screen 30.

The user selects a desired layout design from the displayed thumbnail group through an input unit such as a mouse and presses the OK button 34. Based on the operation, the page design application displays the selected layout design on the main screen 10. A frame border 36 is a frame border indicating that the image is selected by the user operation.

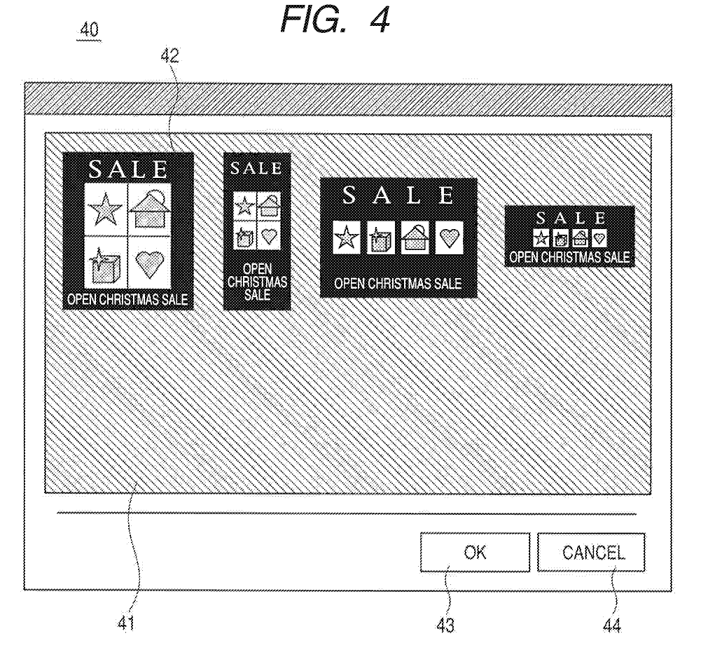

FIG. 4 illustrates a size variation design display screen 40.

The user uses the input unit 1901 such as a mouse to select an arbitrary basic layout design thumbnail displayed in the basic layout design display area 31 and presses the size variation button 33. This leads the page design application to display the size variation design display screen 40 illustrated in FIG. 4. The data entered on the screen of FIG. 1 is applied to individual templates in the variation group to which the selected basic layout design belongs to display the size variation design display screen 40. The present embodiment describes the generation of a derived design generated as a variation design with different image size (paper size) after printing of the design. The derived design related to the paper size will be called a size variation design.

A template group giving the same impression and the same taste as the basic layout design belongs to the variation group, even though the designs have different printing paper sizes or different length to width ratios (also called “aspect ratios”) with the same paper size. For example, it is assumed that the basic layout design is a design in which A2 size paper is vertically used. Examples of the size variation designs include a design in which A2 size paper is horizontally used, a design in which A3 size paper is vertically used, a design in which paper with 80 cm length and 3 m width is horizontally used, and a design in which paper with 2 m length and 50 cm width is vertically used. As for the A2 size vertical design, the A2 size horizontal design, the horizontal design with 1 m length and 3 m width, and the horizontal design with 2 m length and 50 cm width are different from the aspect ratio of the A2 size vertical design, and the A3 size vertical design has a different image size (paper size). Taking a poster used in a store as an example, applications of these printed materials include the following. The A2 size vertical and A2 size horizontal designs are used for the board at the entrance of the store and main walls in the store. The horizontal design with 80 cm length and 3 m width is hung from the ceiling of the store. The horizontal design with 2 m length and 50 cm width is used for the poles of the store. The A3 size vertical design is used for walls of sales rooms. The layouts of the A2 size vertical design and the A3 size vertical design can be the same. However, the design may give different impressions when the paper size is changed, depending on the distance from the observer to the printed material. Therefore, the design may be varied to give the same impression. As illustrated in FIG. 4, the derived layout design is a design in which the arrangement and the relative size of the characters and images are changed from the basic layout design. The impression of the observer usually changes if the colors used for the characters and background are changed. Therefore, the colors of the characters and background used in the derived design are the same as in the basic design. However, if the legibility of the characters is degraded due to the character size, the colors of the characters or background may be changed to the extent that the impression of the observer does not change.

The lower left design (image with the frame border 36) is selected from the basic layout design group displayed on the basic layout design group display screen 30, and the size variation button 33 is pressed to display the design on the size variation design display screen 40.

The size variation design display screen 40 displays a size variation design display area 41, a size variation design candidate thumbnail 42, an OK button 43, and a cancel button 44.

A design group with different paper sizes or aspect ratios are displayed in the size variation design display area 41 as size variation designs of the selected basic design.

Pressing of the cancel button 44 on the size variation design display screen 40 returns the display to the basic layout design group display screen illustrated in FIG. 3. When the OK button 43 is pressed while an arbitrary derived layout design is selected, the design is displayed on the main screen 10 of the application.

A process of displaying the basic layout design group display screen according to the input by the user will now be described.

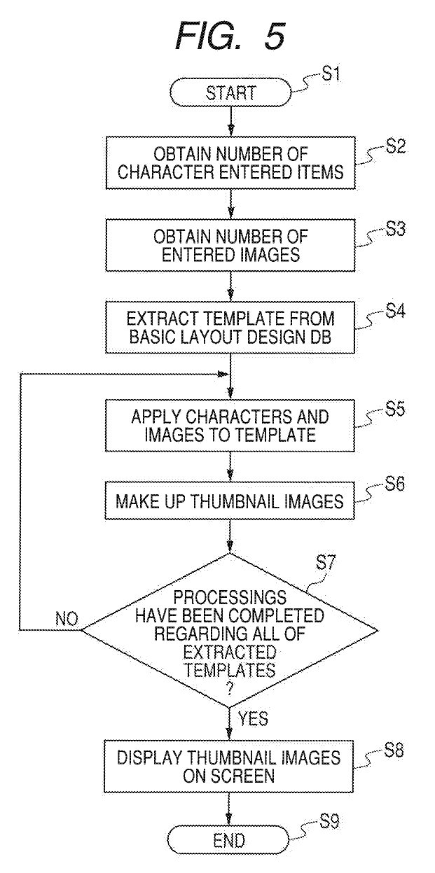

FIG. 5 is a flow chart of a process of displaying the basic layout design group display screen according to the input by the user. The flow chart is stored in the memory unit 1904 as part of the program of the page design application and is executed by the CPU 1902.

A generation process of a basic layout design candidate starts in S1 of FIG. 5. This is equivalent to the pressing of the “NEXT” button B3 in FIG. 2.

In S2, whether the user has entered characters into the title entering area 21, the sub-title entering area 22, the text entering area 23, and the organization name entering area 24 illustrated in FIG. 2 is determined. In this case, the title and the sub-title are entered.

In S3, the number of images entered by the user into the user image entering area 25 is obtained. In this case, the number of images 4 is obtained. In S4, based on the information “the title obtained in the above steps is entered, the sub-title is entered, and the number of images is 4”, a relevant basic layout template is extracted from the basic layout database installed in the system. The basic layout design is a layout design designed according to the presence/absence of four types of text data including title, sub-title, text, and name of organization and according to the number of images used. The presence/absence of entering of each of the four types of text and the number of entered images are set as extraction conditions in the basic layout template describing the basic layout designs. The basic layout database including a plurality of basic layout templates is stored in the memory unit 1904. It is assumed in the first embodiment that eight templates satisfying the conditions are extracted from the basic layout database.

The basic layout database is installed at the same time as the installation of the application and includes a series of predesigned design template groups having differences in the presence/absence of four types of text entering areas and the number of images. The installed basic layout database is stored in the memory unit 1904.

In S5, the extracted basic layout templates are read from the memory unit 1904, respectively, and the characters and images input by the user are applied to the read basic layout templates. The generated designs are stored in a temporary directory in the system as a temporary file.

In S6, thumbnail images of the generated designs are generated and stored in the system as a temporary file likewise.

In S7, whether all templates extracted in S4 are processed is determined. If there are unprocessed templates, the process returns to S5, and the next template is processed.

If it is determined in S7 that all templates are processed, the process proceeds to S8, and thumbnail images of the generated basic layout design group are displayed on the screen 30 as illustrated in FIG. 3.

For example, the user selects the lower left design thumbnail (thumbnail with the frame border 36) on the screen 30 as described above and instructs the creation of size variation designs with different paper sizes based on the design.

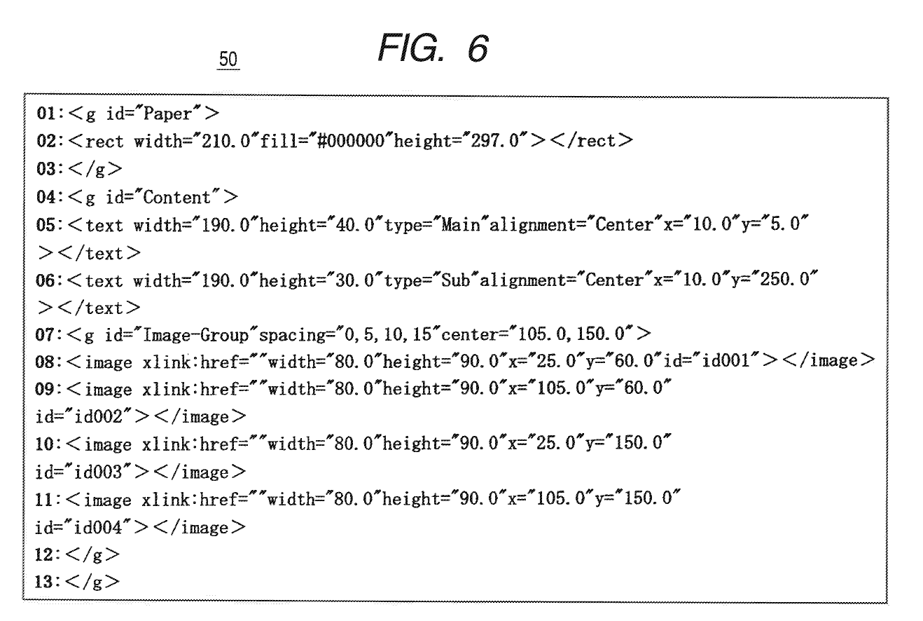

FIG. 6 schematically illustrates a file structure 50 of a selected basic design.

A row 02 in FIG. 6 indicates that the basic layout template is designed with a basic size of 210 mm width and 297 mm height.

Rows 05 and 06 define entering areas of the title and the sub-title. The title and the sub-title are identified by whether the “type” attribute is “Main” or “Sub”.

FIG. 6 illustrates an example in which the text and the name of organization are not input. If the text and the name of organization are input, a template with corresponding text entering area is extracted from the template database.

Rows 07 to 12 are put together by tags “g”, indicating that the rows form one group.

Rows 08 to 11 correspond to the image areas and indicate in FIG. 6 that the layout is such that four image areas with 80 mm width and 90 mm height are concentrated at the center of the page. In the image areas, images are allocated by the “id” attribute in the order of input by the user.

A derived layout design of spacing of images is embedded in advance in the basic layout template. The embedded derived layout design of spacing of images is indicated by spacing=“0,5,10,15” of the row 07. The derived design of spacing of images is a derived design for changing the impression by the observer of the basic layout design and is not the size variation design.

The derived design indicates the arrangement of the intervals (spaces) between images (entered images 1 to 4 in this case) bundled as a group. The default value is 0, which denotes a closely attached state.

Also, it is indicated that a derived layout design with spaces 5 mm, 10 mm, and 15 mm can be generated. The user operates the operation menu not shown to select the spaces between the images.

A process after the user has selected a basic layout design and the size variation button 33 illustrated in FIG. 3 is pressed will now be described.

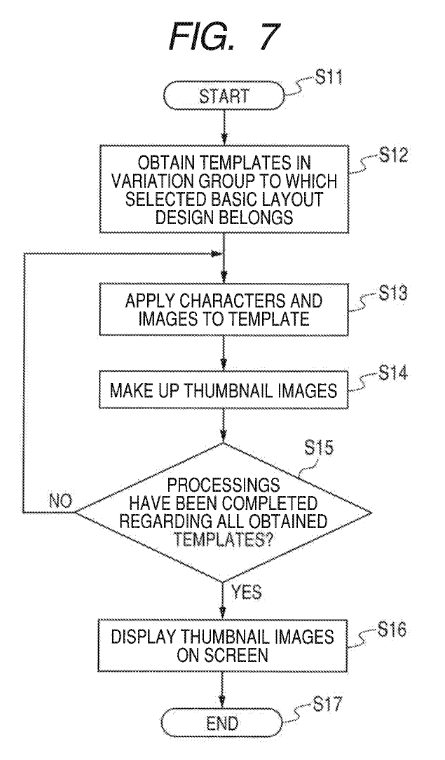

FIG. 7 is a flow chart of a process after the user has selected a basic layout design and the size variation button 33 illustrated in FIG. 3 is pressed. The flow chart is stored in the memory unit 1904 as part of a program of the page design application, and the CPU 1902 executes the flow chart.

A generation process of size variation starts in S11, which is equivalent to the pressing of the size variation button 33 illustrated in FIG. 3.

In S12, a template group with different paper sizes in the variation group to which the basic layout template as a base of the selected basic layout design belongs is obtained from the above-mentioned basic layout database. The obtaining from the basic layout database is equivalent to reading-out of templates of the size variation design associated with the basic layout design selected from the layout database stored in the memory unit 1904. The number of templates in the variation group does not have to be fixed. The number of templates may differ depending on the group. For example, a group n includes four templates, and a group m includes five templates.

In S13 to S15, a process of applying the characters and the images to the templates in the variation group is repeated. In S13, the characters and the images input by the user are applied to the obtained templates. The process of S13 will now be described in detail. The characters and the images used in S13 are the characters and the images input based on the user operation to the basic layout design group generating screen 20 illustrated in FIG. 2. These are the characters and the images applied to the templates to generate basic layout designs corresponding to the thumbnails displayed on the basic layout design group display screen 30 of FIG. 3. Thus, in the case of FIG. 2, the characters are the title “SALE” and the sub-title “OPEN CHRISTMAS SALE”, and there are four images: the first user entered image 26, the second user entered image 27, the third user entered image 28, and the fourth user entered image 29. The characters and the images are applied to the templates in the variation group in S13. In S14, a thumbnail file for screen display is generated as a temporary file. In S15, whether all templates in the variation group are processed is determined. If it is determined that all templates are processed, the process proceeds to S16.

In S16, the generated thumbnail images are displayed on the screen as illustrated in FIG. 4, and the process ends in S17.

The execution of the process can display designs, in which the characters and the images are applied to the templates with different paper sizes in the variation group obtained in S12, and allows the user to select a desired design.

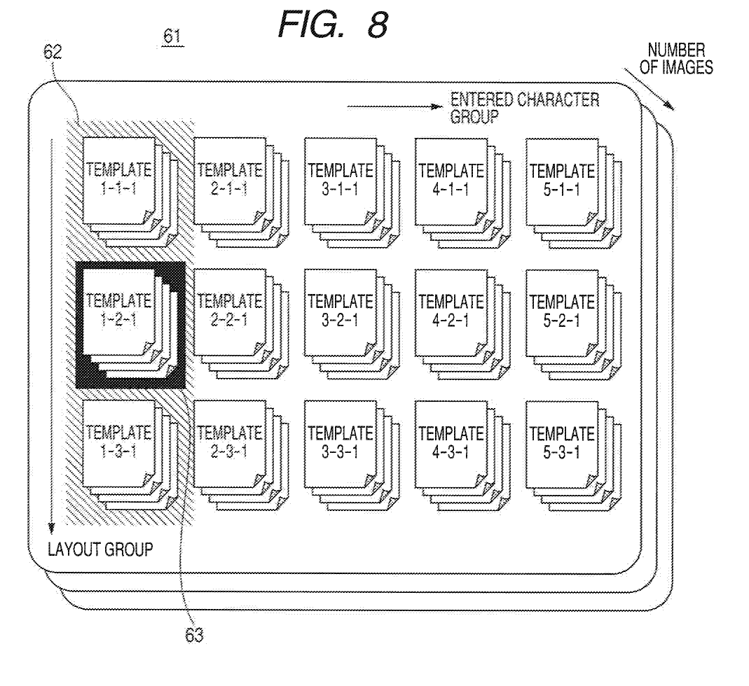

FIG. 8 illustrates a concept of a basic layout database storing template groups 61 made up by the graphic designer.

The basic layout database stores templates as bases for the designs generated and displayed on the screen illustrated in FIGS. 3 and 4, and the templates are classified into levels of the number of entered images, entered character group, layout group, and identical variation group.

The template groups 61 corresponding to the number of images 1 are stored as templates, and the templates are classified based on entered character groups and layout groups. In FIG. 8, the longitudinal direction indicates variations of the basic layout, and the lateral direction indicates variations in the entered character groups.

Template groups for the numbers of images 2, 3, 4, and so on having the same configuration as the template groups 61 corresponding to the number of images 1 are stored and classified based on corresponding numbers of images on the basic layout database.

Template groups with layouts, in which all basic layout designs are different, are stored in the longitudinal direction. In other words, template groups with layouts, each giving different impression to the user, are stored. An example of this is a group 62. The design group generated in FIG. 3 is based on the templates belonging to the group in the longitudinal direction, and designs, each giving different impression, are generated.

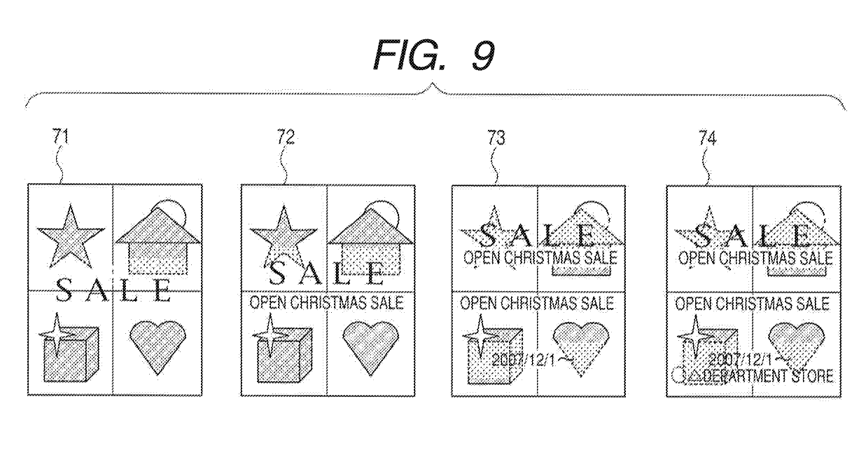

Templates with layouts based on the entered character groups are stored in the lateral direction. In other words, templates with layouts that differ depending on the type of input characters are stored. The difference in the impressions of the individual designs for the user is usually significantly small because the basic designs are in the same group. The templates are designed to give identical impression and taste in the design. The detail is illustrated in FIG. 9. FIG. 9 will be described later.

A variation group 63 of FIG. 8 is an identical entered group, the variation group 63 including identical layout designs and storing templates with different paper sizes. The designs generated based on the template groups are constituted by templates with different paper sizes or aspect ratios without changing the information or impression to the observer. The entered characters and the images are applied to the individual templates in the variation group to which the basic layout design selected from the basic layout design group display screen 30 illustrated in FIG. 3 belongs. A state that designs are generated is illustrated in FIG. 4.

The templates located at the top of the variation group serve as the basic layout designs that are designs displayed on the basic layout design group display screen 30 illustrated in FIG. 3.

FIG. 9 illustrates an example of types of designs based on the entered character group.

FIG. 9 illustrates that the layout designs included in the templates extracted from the basic layout database are different depending on the type of entered characters even within the same layout group in which the impression and taste of design are designed to be identical.

A design 71 is a design generated from a template extracted when the characters are entered only at the title.

A design 72 is a design generated from a template extracted when the characters are entered only at the title and the sub-title. The input state illustrated in FIG. 2 is equivalent to this condition.

A design 73 is a design generated from a template extracted when the characters of the title, the sub-title, and the text are entered.

A design 74 is a design generated from a template extracted when the characters of the title, the sub-title, the text, and the name of organization are all entered.

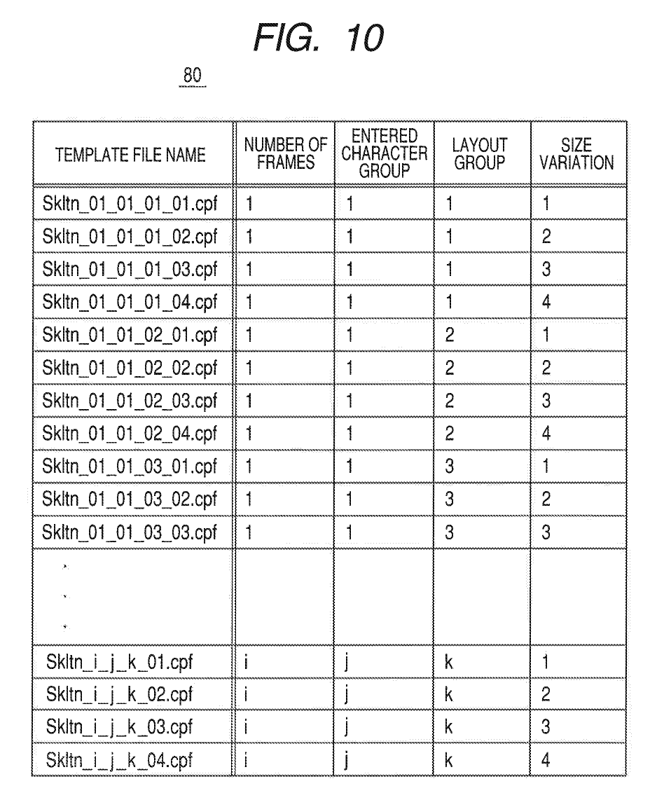

FIG. 10 illustrates index data 80 for searching and specifying a template on the basic layout database.

From the left, the index data 80 includes columns of template file name, number of image frames, entered character's group number, layout group number, and size variation number, and the files are classified based on the attributes. As described, the number of paper size variations may be different depending on the variation group.

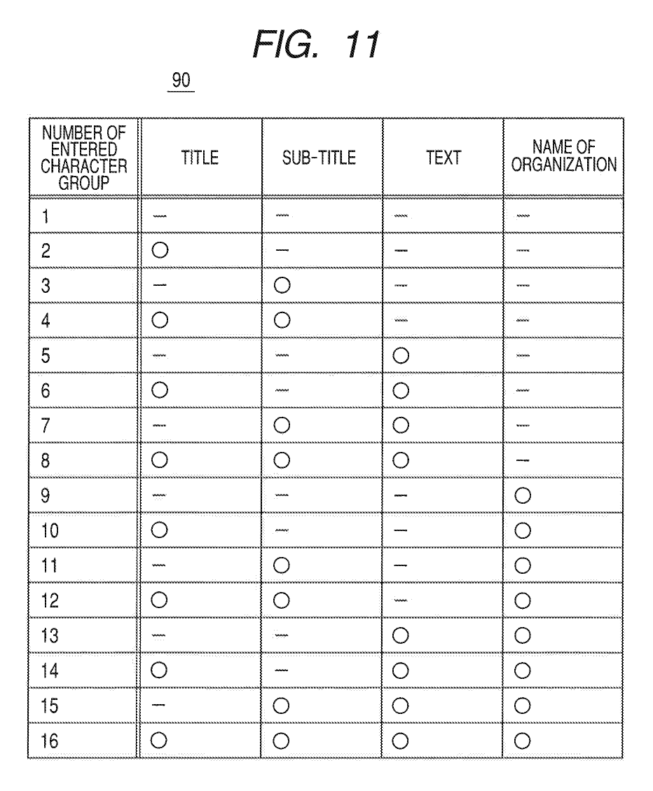

The number of entered character groups indicates the number provided for each type of combination of the entered characters, and the detail is illustrated in FIG. 11.

When the basic layout design of FIG. 3 is generated, there is extracted a template that includes an attribute corresponding to the group number obtained from the combination of the number of images and the entered characters input in FIG. 2, and also includes an attribute of size variation number 1. The extracted template is a template of the basic layout design. In this way, the extracted templates are constituted by designs with different layout groups as illustrated in the group 62.

FIG. 11 illustrates a correspondence table 90 of the numbers of entered character groups stored in the index data 80 illustrated in FIG. 10 and types of combinations of the entered characters.

In the correspondence table 90, the mark ◯ indicates that the characters are entered. For example, if the entered character's group number is 6, only the title and the text are entered.

In the above embodiment, the derived layout design is a design in which the attributes of the elements constituting the layout are different from those in the basic layout design.

Furthermore, the derived layout design is a design in which at least one of the paper size and the aspect ratio is different from that in the basic layout design.

If the characters are not entered, a variation group called entered character's group number 1 is prepared, and a page design with only images is generated.

In the description of the present embodiment, the objects to be laid out for the page design in the page design application are characters, raster data (photographic image data), and vector data (figure data). If the raster data and the vector data are collectively assumed to be images, it can be said that the page layout application is a design editing application for laying out characters or images. The page design application can generate and edit a design with only characters or a design with only images. Although variations related to the size have been described as an example of the derived design in the present embodiment, the present invention can also be implemented with variations related to other ones than the size. For example, in the case of color variation, templates of the basic design and templates of derived designs different in color design from the basic design are associated and stored. The present invention can be realized by displaying the associated basic design and derived designs with different colors according to the operation by the user for displaying the color variations. The derived designs are color designs made up by the graphic designer. Therefore, few derived designs associated with the basic design selected by the user can be displayed, and compared to the conventional techniques, the user has no trouble finding a desired design from a multiplicity of generated designs. It has been described that the page design application is installed on a personal computer and executed on the personal computer. However, the arrangement is not limited to this, and the present invention can be realized by the system of a server and a client computer connected through a network. For example, the page design application can be installed on the server, and the user can enter operations, characters, and images to display the screen on the client computer connected through the network to implement the present invention.

According to the present invention, derived designs related to a basic design selected by the user from generated basic designs are automatically generated. Therefore, the user can more easily select a desired design compared to techniques in which a list of all basic designs and all derived designs that can be generated is displayed for the user to select.

Furthermore, according to the present invention, derived designs related to a basic design selected by the user from generated basic designs are automatically generated. Therefore, the user can more easily obtain a derived design even if the user has little design knowledge, and the operation efficiency of design creation is improved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-157610, filed Jun. 17, 2008 which is hereby incorporated by reference herein in its entirety.

What is claimed is:

1. A design generating apparatus comprising:
a display unit that displays a design;
an operation unit that accepts an operation by a user;
an input unit that inputs a character or an image used for the design based on the operation by the user accepted by the operation unit;
a generating unit that applies the character or the image input from the input unit to a design template to generate the design; and
a memory unit that stores a template of a basic design corresponding to a combination of the character and the image and a template of a derived design associated with the basic design,
wherein the generating unit applies the character or the image input from the input unit to the template of the basic design read from the memory unit to generate the basic design, displays an image of the basic design on the display unit, reads the template of the derived design associated with the basic design selected, based on an operation by the user, from the memory unit, applies the character or the image used to generate the basic design to generate the derived design, and displays an image of the derived design on the display unit.

2. The design generating apparatus according to claim 1, wherein
the derived design is a design in which a layout of the character or the image is different from that in the basic design.

3. The design generating apparatus according to claim 1, wherein
the input unit displays on the display unit a screen for inputting a character or an image used for the basic design.

4. The design generating apparatus according to claim 1, wherein
the derived design is a design in which at least one of a paper size and an aspect ratio when printed is different from that of the basic design.

5. The design generating apparatus according to claim 1, further comprising
a control unit that displays the derived design, for which the user has executed a selection operation to the image of the derived design displayed on the display unit, on a screen for editing the design.

6. A design generation method comprising:
operating for accepting an operation by a user;
inputting a character or an image used for the design based on the operation by the user accepted in the operating; and
generating for applying the character or the image input in the inputting to a design template to generate the design, wherein
in the generating, a template of a basic design is read from a memory unit storing the template of the basic design corresponding to a combination of the character and the image and a template of a derived design associated with the basic design, the character or the image input in the inputting is applied to the template of the basic design to generate the basic design, an image of the basic design is displayed on the display unit, the template of the derived design associated with the basic design selected based on an operation by the user is read from the memory unit, the character or the image used to generate the basic design is applied to generate the derived design, and an image of the derived design is displayed on the display unit.

7. The design generation method according to claim 6, wherein
the derived design is a design in which a layout of the character or the image is different from that in the basic design.

8. The design generation method according to claim 6, wherein
in the inputting, a screen is displayed on the display unit, for inputting a character or an image used for the basic design.

9. The design generation method according to claim 6, wherein
the derived design is a design in which at least one of a paper size and an aspect ratio when printed is different from that of the basic design.

10. The design generation method according to claim 6, further comprising
controlling for displaying the derived design, for which the user has executed a selection operation to the image of the derived design displayed on the display unit, on a screen for editing the design on the display unit.

11. A storage medium storing a design generation program for causing a computer to execute:
operating for accepting an operation by a user;
inputting a character or an image used for the design based on the operation by the user accepted in the operating; and
generating for applying the character or the image input in the inputting to a design template to generate the design,
wherein the generating causes the computer to
read a template of a basic design from a memory unit storing the template of the basic design corresponding to a combination of the character and the image and a template of a derived design associated with the basic design, apply the character or the image input in the inputting to the template of the basic design to generate the basic design, display an image of the basic design on the display unit, read the template of the derived design associated with the basic design selected based on an operation by the user from the memory unit, apply the character or the image used to generate the basic design to generate the derived design, and display an image of the derived design on the display unit.

12. The storage medium storing the design generation program according to claim 11, wherein
the derived design is a design in which a layout of the character or the image is different from that in the basic design.

13. The storage medium storing the design generation program according to claim 11, wherein
in the inputting, a screen is displayed on the display unit for inputting a character or an image used for the basic design.

14. The storage medium storing the design generation program according to claim 11, wherein
the derived design is a design in which at least one of a paper size and an aspect ratio when printed is different from that of the basic design.

15. The storage medium storing the design generation program according to claim 11, further comprising
controlling for displaying the derived design, in which the user has executed a selection operation to the image of the derived design displayed on the display unit, on a screen for editing the design on the display unit.
